(19) United States
(12) Patent Application Publication
(10) Pub. No.: US 2019/0067745 A1
(43) Pub. Date: Feb. 28, 2019

(54) METHOD FOR PREPARING SOLID ELECTROLYTES USING SONOCHEMICAL PROCESS

(71) Applicant: KOREA INSTITUTE OF SCIENCE AND TECHNOLOGY, Seoul (KR)

(72) Inventors: Hyoungchul KIM, Seoul (KR); Hae-Weon LEE, Seoul (KR); Byung Kook KIM, Seoul (KR); Jong Ho LEE, Seoul (KR); Ji-Won SON, Seoul (KR); Hun-Gi JUNG, Seoul (KR); Sung Jun CHOI, Seoul (KR); Eu Deum JUNG, Seoul (KR)

(21) Appl. No.: 15/991,580

(22) Filed: May 29, 2018

(30) Foreign Application Priority Data
Aug. 30, 2017 (KR) 10-2017-0109842

(51) Int. Cl. H01M 10/0585; H01M 10/0562; H01M 10/052

(52) U.S. Cl. CPC H01M 10/0585; H01M 10/0562; C01D 15/00; H01M 2300/0068; H01M 10/052

(57) ABSTRACT

The present invention relates to a method for preparing a solid electrolyte using a sonochemical process, which includes a step of preparing a reaction vessel holding a solid electrolyte raw material in a solid or liquid form and a step of reacting the solid electrolyte raw material by applying energy into the reaction vessel by irradiating an ultrasound to the reaction vessel.

### CROSS-REFERENCE TO RELATED APPLICATIONS

This application claims, under 35 U.S.C. § 119, the priority of Korean Patent Application No. 10-2017-0109842, filed on Aug. 30, 2017, in the Korean Intellectual Property Office, the disclosure of which is incorporated herein by reference in its entirety.

### BACKGROUND

### (a) Technical Field

The present invention relates to a method for preparing a solid electrolyte using a sonochemical process, more particularly to a method capable of significantly reducing processing time and preparing a solid electrolyte with a distinct shape having a high aspect ratio.

### (b) Background Art

At present, secondary batteries are widely used not only in large-sized devices such as vehicles, power storage systems, etc. but also in small-sized devices such as mobile phones, camcoders, notebook computers, etc.

As the secondary batteries are used in wide applications, the requirement for battery safety and performance improvement is increasing.

Among the secondary batteries, a lithium secondary battery is advantageous over a nickel-manganese battery or a nickel-cadmium battery due to high energy density and large capacity per unit area.

However, most of the electrolytes used in the existing lithium secondary batteries are liquid electrolytes such as organic solvents. For this reason, leakage of the electrolyte and safety issues such as the risk of fire, etc. have been constant problems.

Therefore, interests are increasing recently in all-solid batteries using organic solid electrolytes rather than organic liquid electrolytes to improve safety.

The solid electrolyte is safer than the liquid electrolyte because it is nonflammable or flame-retardant.

The solid electrolytes are classified into oxide-based and sulfide-based electrolytes. The sulfide-based solid electrolytes are mainly used because they exhibit high lithium ion conductivity and superior low-temperature modlability as compared to the oxide-based solid electrolytes.

Japanese Patent Publication No. H11-134937 and Japanese Patent Publication No. 2002-109955 disclose a sulfide-based solid electrolyte prepared by pulverizing a raw material by high-energy milling using a planetary mill.

Specifically, as shown in FIG. 1, a solid electrolyte is prepared by mixing solid electrolyte raw materials (S70), mechanically milling the mixture using a planetary ball mill, etc. (S80) and then heat-treating the same (S80).

However, the dry high-energy milling technique requires mechanical milling (S80) for at least 6 hours using an expensive equipment of a gas-tight structure for uniform mixing and vitrification of the raw materials. These limitations become a big obstacle to mass production of solid electrolytes and practical use of all-solid batteries.

### SUMMARY

The present invention is directed to providing a method capable of preparing a solid electrolyte in short time.

The present invention is also directed to providing a method capable of preparing a solid electrolyte in which respective components are distributed uniformly.

The present invention is also directed to providing a method capable of preparing a solid electrolyte of a distinct shape.

The present invention is also directed to providing a preparation method capable of significantly improving the productivity of a solid electrolyte.

The purposes of the present invention are not limited to those described above. The features and aspects of the present invention will be apparent from the following detailed description and will be embodied by the means described in the claims and combinations thereof.

A method for preparing a solid electrolyte using a sonochemical process according to an exemplary embodiment of the present invention includes a step of preparing a reaction vessel holding a solid electrolyte raw material in a liquid form and a step of reacting the solid electrolyte raw material by applying energy into the reaction vessel by irradiating an ultrasound to the reaction vessel.

The solid electrolyte raw material may contain 10-40 mol % of a sulfide-based raw material selected from a group consisting of P₂S₃, P₂S₅, P₄S₃, P₄S₅, P₄S₇, P₄S₁₀ and a combination thereof and 60-90 mol % of lithium sulfide (Li₂S).

The solid electrolyte raw material may be dissolved in a polar organic solvent selected from a group consisting of an ester-based solvent, a carbonate-based solvent, an ether-based solvent, a furan-based solvent and a combination thereof.

The step of reacting the solid electrolyte raw material may be conducted by irradiating an ultrasound with a frequency of 20-2,000 kHz to the reaction vessel for 1 minute to 6 hours.

The step of reacting the solid electrolyte raw material may be conducted at −50° C. to 200° C.

The step of reacting the solid electrolyte raw material may include sealing the reaction vessel, immersing the reaction vessel in a water bath equipped with an ultrasound generating apparatus and filled with a medium and then irradiating an ultrasound to the reaction vessel.

The method for preparing a solid electrolyte may further include a step of drying a product obtained by reacting the solid electrolyte raw material.

The method for preparing a solid electrolyte further may further include a step of heat-treating the dried product at 250-800° C. for 1 minute to 100 hours.

The solid electrolyte may have a shape selected from a group consisting of a sphere, a plate, a needle and a combination thereof.

A continuous circulation reactor for preparing a solid electrolyte using a sonochemical process according to another exemplary embodiment of the present invention includes a storage reservoir holding a solid electrolyte raw material in a liquid form, an ultrasound generator including a reaction tube and an ultrasound irradiation means which is located outside the reaction tube and reacts the solid electrolyte raw material by applying energy into the reaction tube by irradiating an ultrasound to the reaction tube, a first transport pipe one end of which is inserted in the storage reservoir and contacts the solid electrolyte raw material and the other end of which is connected to a circulation pump; a second transport pipe one end of which is connected to the circulation pump and the other end of which is linked with one end of the reaction tube; a third transport pipe one end of which is linked with other end of the reaction tube and the other end of which is inserted in the storage reservoir and the circulation pump which allows the solid electrolyte raw material to flow from the storage reservoir through the reaction tube and again into the storage reservoir.

The flow rate of the solid electrolyte raw material passing through the cross section of the reaction tube is 0.01-50 m/min.

The ultrasound irradiation means may irradiate an ultrasound with a frequency of 20-2,000 kHz.

The continuous circulation reactor may further include a temperature controller controlling the temperature of the reaction tube to −50° C. to 200° C.

A method for preparing a solid electrolyte using a sonochemical process according to another exemplary embodiment of the present invention uses the continuous circulation reactor and includes a step of allowing the solid electrolyte raw material held in the storage reservoir to pass through a first transport pipe, the circulation pump and the second transport pipe and to flow into the reaction tube of the ultrasound generator, a step of reacting the solid electrolyte raw material by irradiating an ultrasound to the solid electrolyte raw material flowing in the reaction tube and a step of flowing the solid electrolyte raw material discharged from the reaction tube through the third transport pipe into the storage reservoir, wherein the steps are repeated.

In the method for preparing a solid electrolyte, the steps may be repeated for 1 minute to 6 hours.

The step of reacting the solid electrolyte raw material may be conducted by irradiating an ultrasound with a frequency of 20-2,000 kHz to the solid electrolyte raw material flowing in the reaction tube.

The step of reacting the solid electrolyte raw material may be conducted in a state where the temperature of the reaction tube is −50° C. to 200° C.

The method for preparing a solid electrolyte may further include a step of drying a product obtained by repeating the steps.

The method for preparing a solid electrolyte may further include a step of heat-treating the dried product at 250-800° C. for 1 minute to 100 hours.

The solid electrolyte may have a shape selected from a group consisting of a sphere, a plate, a needle and a combination thereof.

According to the method for preparing a solid electrolyte according to an exemplary embodiment of the present invention, productivity can be greatly improved because a solid electrolyte having a distinct shape can be prepared in a short time.

The effects of the present invention are not limited to those described above. It is to be understood that all the effects that can be inferred from the following description are included in the scope of the present invention.

### BRIEF DESCRIPTION OF DRAWINGS

FIG. 1 is a schematic flow chart of the existing method for preparing a solid electrolyte using a high-energy milling process.

FIG. 2 a schematic flow chart of a method for preparing a solid electrolyte according to an exemplary embodiment of the present invention.

FIG. 3 is a cross-sectional view of a batch-type apparatus for synthesizing a solid electrolyte according to an exemplary embodiment of the present invention.

FIG. 4 is a cross-sectional view of a continuous circulation-type apparatus for synthesizing a solid electrolyte according to an exemplary embodiment of the present invention.

FIGS. 5A-5D show a result of monitoring the change of a solid electrolyte raw material according to a batch method depending on reaction time (FIG. 5A: before start of reaction, FIG. 5B: after reaction for 15 minutes, FIG. 5C: after reaction for 45 minutes, FIG. 5D: after reaction for 120 minutes).

FIG. 6A shows a scanning electron microscopy (SEM) analysis result of a solid electrolyte according to Example 1.

FIG. 6B shows a scanning electron microscopy analysis result of a solid electrolyte according to Example 2.

FIG. 7A shows a scanning electron microscopy analysis result of a solid electrolyte according to Example 3.

FIG. 7B shows a scanning electron microscopy analysis result of a solid electrolyte according to Example 4.

FIG. 8A shows a scanning electron microscopy analysis result of a solid electrolyte according to Comparative Example 1.

FIG. 8B shows a scanning electron microscopy analysis result of a solid electrolyte according to Comparative Example 2.

FIG. 9A shows a scanning electron microscopy analysis result of a solid electrolyte according to Comparative Example 3.

FIG. 9B shows a scanning electron microscopy analysis result of a solid electrolyte according to Comparative Example 4.

FIG. 10 shows an X-ray diffraction (XRD) analysis result of solid electrolytes according to Example 2 and Comparative Example 2.

FIG. 11 shows an X-ray diffraction analysis result of solid electrolytes according to Example 4 and Comparative Example 4.

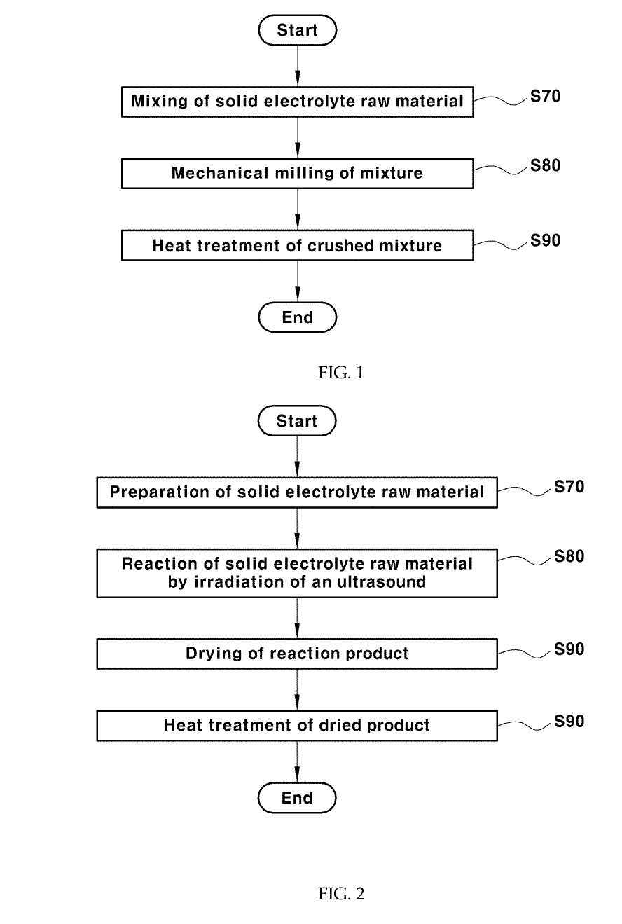

### DETAILED DESCRIPTION

Objectives, other objectives, features and advantages of the present invention will be easily understood through the following detailed description of specific exemplary embodiments and the attached drawings. However, the present invention is not limited to the exemplary embodiments and may be embodied in other forms. On the contrary, the exemplary embodiments are provided so that the disclosure of the present invention is completely and fully understood by those of ordinary skill.

In the attached drawings, like numerals are used to represent like elements. In the drawings, the dimensions of the elements are magnified for easier understanding of the present invention. Although the terms first, second, etc. may be used to describe various elements, these elements should not be limited by the terms. The terms are used only to distinguish one element from another. For example, a first element can be termed a second element and, similarly, a second element can be termed a first element, without departing from the scope of the present invention. A singular expression includes a plural expression unless the context clearly indicates otherwise.

In the present disclosure, the terms such as “include”, “contain”, “have”, etc. should be understood as designating that features, numbers, steps, operations, elements, parts or combinations thereof exist and not as precluding the existence of or the possibility of adding one or more other features, numbers, steps, operations, elements, parts or combinations thereof in advance. In addition, when an element such as a layer, a film, a region, a substrate, etc. is referred to as being “on” another element, it can be “directly on” the another element or an intervening element may also be present. Likewise, when an element such as a layer, a film, a region, a substrate, etc. is referred to as being “under” another element, it can be “directly under” the another element or an intervening element may also be present.

FIG. 2 is a schematic flow chart of a method for preparing a solid electrolyte according to first exemplary embodiment of the present invention.

Referring to FIG. 2, a method for preparing a solid electrolyte according to a first exemplary embodiment of the present invention includes a step of preparing a reaction vessel holding a solid electrolyte raw material in a solid or liquid form (S10), a step of reacting the solid electrolyte raw material by applying energy into the reaction vessel by irradiating an ultrasound to the reaction vessel (S20), a step of drying a product obtained by reacting the solid electrolyte raw material (S30) and a step of heat-treating the dried product (S40).

The step of preparing the solid electrolyte raw material (S10) may be a step of preparing a reaction vessel holding a solid electrolyte raw material containing a sulfide-based raw material and lithium sulfide (Li₂S) in a solid or liquid form

The sulfide-based raw material may be selected from a group consisting of P₂S₃, P₂S₅, P₄S₃, P₄S₅, P₄S₇, P₄S₁₀ and a combination thereof. Specifically, diphosphorus pentasulfide (P₂S₅) may be used.

The sulfide-based raw material may further contain a substitutional element. The substitutional element may be boron (B), carbon (C), nitrogen (N), aluminum (Al), silicon (Si), vanadium (V), manganese (Mn), iron (Fe), cobalt (Co), nickel (Ni), copper (Cu), zinc (Zn), gallium (Ga), germanium (Ge), arsenic (As), selenium (Se), silver (Ag), cadmium (Cd), indium (In), tin (Sn), antimony (Sb), tellurium (Te), lead (Pb), bismuth (Bi), etc.

Specifically, the lithium sulfide may be one containing little impurities to reduce side reactions. The lithium sulfide may be synthesized by the method of Japanese Patent Publication No. 7-330312 GP 7-330312 A) and may be purified by the method of International Patent Publication No. WO 2005/040039.

The solid electrolyte raw material may be one wherein the sulfide-based raw material and the lithium sulfide are mixed at a molar ratio of 60:40 to 90:10. If the molar ratio of the sulfide-based raw material and the lithium sulfide is lower than 60:40, charge capacity and discharge capacity may decrease when applied to an all-solid battery due to insufficient amount of lithium. In addition, if the molar ratio exceeds 90:10, the transport of electrons may be interrupted when it is applied to an all-solid battery due to excessive amount of lithium.

The solid electrolyte raw material may be one obtained by mixing the sulfide-based raw material and the lithium sulfide and then vitrifying the same through mechanically milling. In the first exemplary embodiment of the present invention, the solid electrolyte raw material may be prepared without the pretreatment described above in order to maximize the effect of reducing processing time. However, the vitrified raw material may also be used as described above depending on the state of the raw material and the kind of the battery and/or solid electrolyte.

The solid electrolyte raw material may further contain, in addition to the sulfide-based raw material and the lithium sulfide, an oxide, a carbide, a nitride, an organic compound, a halogen compound, a metal-containing compound, etc., depending on the kind of the solid electrolyte.

The solid electrolyte raw material is prepared into a solid or liquid form. The solid form refers to a powder of a solid electrolyte raw material precursor and the liquid form refers to a solid electrolyte raw material precursor dissolved in a specific solvent. An appropriate form may be selected depending on ultrasound irradiation method, ultrasound generating apparatus, etc.

When the solid electrolyte raw material is prepared into a liquid form, the solid electrolyte raw material may be dissolved in a polar organic solvent.

The polar organic solvent is not specially limited as long as it can dissolve the solid electrolyte raw material. For example, it may be selected from a group consisting of an ester-based solvent such as ethyl propionate (C₅H₁₀O₂) and ethyl acetate (C₄H₈O₂); a carbonate-based solvent such as dimethyl carbonate (C₃H₆O₃); an ether-based solvent such as dimethoxyethane (C₄H₁₀O₂); and a furan-based solvent such as tetrahydrofuran (C₄H₈O) and a combination thereof.

The reaction vessel may be one into which a gas of an inert atmosphere has been injected after removing air inside thereof. The gas of an inert atmosphere may refer to an inert gas such as helium (He), argon (Ar), nitrogen (N₂), etc. If the solid electrolyte raw material is supplied and prepared after the inside of the reaction vessel has been prepared into an inert atmosphere, the occurrence of side reactions can be prevented.

The step of reacting the solid electrolyte raw material by irradiating an ultrasound (S20) may be a step of reacting the solid electrolyte raw material by applying energy into the reaction vessel by irradiating an ultrasound to the reaction vessel holding the solid electrolyte raw material.

According to the first exemplary embodiment of the present invention, a solid electrolyte with a distinct shape can be synthesized in a short time through the sonochemical process as described above.

In the sonochemical process according to the first exemplary embodiment of the present invention, physical and chemical reactions are induced by applying ultrasound energy to the solid electrolyte raw material unlike the existing process of using inertial energy, or physical pulverization by the rotational motion of a milling medium.

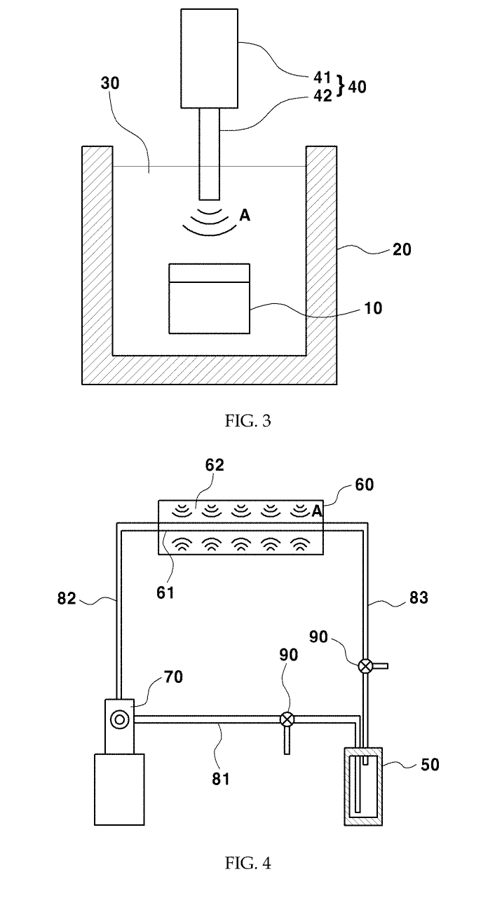

FIG. 3 is a cross-sectional view of a batch-type reactor for preparing a solid electrolyte according to the first exemplary embodiment of the present invention.

Referring to FIG. 3, the step of reacting the solid electrolyte raw material by irradiating an ultrasound (S20) may be conducted by sealing the reaction vessel 10 holding the solid electrolyte raw material, immersing the reaction vessel 10 in a water bath 20 filled with a medium 30 capable of delivering an ultrasound and then irradiating an ultrasound to the reaction vessel 10 (A) using an ultrasound generating apparatus 40 including an ultrasound generator 41 and a probe 42.

The ultrasound generated by the probe 42 forms acoustic cavitation in the liquid medium 30. As a result, cavitation is formed also in the reaction solution inside the reaction vessel 10 within the medium 30 and a continuous repeated process of bubble formation, growth and disruption occurs. As immense energy accumulated inside the bubble, extremely high temperature (up to about 5,000° C.) and pressure (up to about 2,000 atm) occur in some region inside the reaction vessel 10. As the energy resulting from the high temperature and high pressure is delivered, the solid electrolyte raw material is mixed uniformly and reacted very quickly and the solid electrolyte is synthesized.

In the method for preparing a solid electrolyte using a sonochemical process according to the first exemplary embodiment of the present invention, the step of reacting the solid electrolyte raw material (S20) is not necessarily conducted by using the apparatus shown in FIG. 3. Any method and apparatus may be used as long as ultrasound energy can be delivered appropriately to the reaction vessel 10.

The ultrasound energy delivered to the solid electrolyte raw material held in the reaction vessel 10 is determined by the frequency of the ultrasound, irradiation time and the kind of the medium 30 filled in the water bath 20. For uniform mixing and fast reaction of the solid electrolyte raw material, the step of reacting the solid electrolyte raw material (S20) may be specifically conducted by irradiating an ultrasound with a frequency of 20-2,000 kHz for 45 minutes to 2 hours and using water as the medium. However, the condition of the step of reacting the solid electrolyte raw material (S20) is not limited thereto but may be changed adequately depending on the kind of the solid electrolyte raw material used and the state (solid, liquid or gas) of the solid electrolyte raw material.

The step of reacting the solid electrolyte raw material (S20) may be conducted at −50° C. to 200° C. This temperature means the temperature of the reaction vessel 10 when the solid electrolyte raw material is reacted. When the apparatus shown in FIG. 3 is used, the temperature of the reaction vessel 10 is substantially the same as the temperature of the medium 30. Therefore, in this case, the temperature may mean the temperature of the medium 30.

The reaction temperature may also be changed adequately depending on the ultrasound irradiation condition, the kind of the solid electrolyte raw material and the state of the solid electrolyte raw material. The temperature may be constant or varying.

The reaction temperature may be controlled by a sensor (not shown) capable of measuring the temperature of the water bath 20, or by attaching an external device (not shown) such as a cooler, a heater, etc. capable of controlling the temperature, etc.

When the reaction temperature is below 0° C., a solute such as calcium chloride may be added to lower the freezing point of the medium 30 or a medium 30 with a freezing point lower than a preset temperature may be used. In addition, when the reaction temperature is very high, the medium 30 supplied further with predetermined time intervals after closing the water bath 20 or a medium 30 with a boiling point higher than a preset temperature may be used. However, any method and apparatus may be used as long as the reaction temperature can be controlled as desired.

The step of drying the reaction product (S30) may be a step of drying the solid electrolyte obtained by reacting the solid electrolyte raw material through the sonochemical process. The drying condition is not specially limited. Specifically, the drying may be conducted under a vacuum condition to prevent side reactions from occurring and to reduce drying time.

The step of heat-treating the dried product (S40) may be a step of crystallizing the dried solid electrolyte through heat treatment.

The heat-treating step may be conducted at 250-800° C. for 1 minute to 100 hours. If the heat treatment temperature is below 250° C. and the heat treatment time is shorter than 1 minute, it may be difficult for the solid electrolyte to form a crystal structure. In addition, if the heat treatment temperature exceeds 800° C. and the heat treatment time exceeds 100 hours, the lithium ion conductivity of the solid electrolyte may be decreased due to change in composition caused by evaporation of components.

In a second exemplary embodiment of the present invention, reaction is conducted while continuously circulating the solid electrolyte raw material unlike the first exemplary embodiment using the batch-type reactor.

FIG. 4 shows a continuous circulation reactor for preparing a solid electrolyte according to the second exemplary embodiment of the present invention.

Referring to FIG. 4, the continuous circulation reactor for preparing a solid electrolyte according to the second exemplary embodiment of the present invention includes: a storage reservoir 50 holding a solid electrolyte raw material in a liquid form; an ultrasound generator 60 including a reaction tube 61 and an ultrasound irradiation means 62; a circulation pump 70 circulating the solid electrolyte raw material held in the storage reservoir 50; and a transport pipe 80 providing a space in which the solid electrolyte raw material can be circulated by connecting the storage reservoir 50, the ultrasound generator 60 and the circulation pump 70 with each other.

The second exemplary embodiment of the present invention is identical to the first exemplary embodiment in that the solid electrolyte raw material is reacted by delivering energy of extremely high temperature (up to about 5,000° C.) and pressure (up to about 2,000 atm) by irradiating an ultrasound to the solid electrolyte raw material.

However, the second exemplary embodiment of the present invention is distinguished from the first exemplary embodiment in that reaction occurs mainly when the solid electrolyte raw material passes through the reaction tube 61 of the ultrasound generator 60 while the solid electrolyte raw material is circulated in the continuous circulation reactor. Therefore, the following description will be given focusing on the distinction of the second exemplary embodiment of the present invention from the first exemplary embodiment. The matters omitted from the following description will be clearly understood from the above description of the first exemplary embodiment.

The ultrasound generator 60 includes the reaction tube 61 which is configured to have a cylindrical shape such that the solid electrolyte raw material circulating in the continuous circulation reactor for preparing a solid electrolyte can pass therethrough and the ultrasound irradiation means 62 which is located outside the reaction tube 61 and reacts the solid electrolyte raw material by applying energy into the reaction tube 61 by irradiating an ultrasound to the reaction tube 61.

The transport pipe 80 serves as a circulation route connecting the storage reservoir 50, the circulation pump 70 and the ultrasound generator 60. The transport pipe 80 includes a first transport pipe 81 one end of which is inserted in the storage reservoir 50 and contacts the solid electrolyte raw material and the other end of which is connected to the circulation pump 70, a second transport pipe 82 one end of which is connected to the circulation pump 70 and the other end of which is linked with one end of the reaction tube 61, and a third transport pipe 83 one end of which is linked with the other end of the reaction tube 61 and the other end of which is inserted in the storage reservoir 50.

A valve 90 may be equipped on the first transport pipe 81 and the third transport pipe 83. Specifically, the valve 90 may be a three-way valve as shown in FIG. 4. Before reacting the solid electrolyte raw material by operating the continuous circulation reactor, a purging process may be conducted to remove the air and water remaining in the transport pipe 80 by controlling the valve 90 on the first transport pipe 81 such that it is linked with the circulation pump 70 only and then injecting an inert gas, etc. through the valve 90 such that the air and water are discharged through the valve 90 on the third transport pipe 83 Conducting the purging process is preferable because the solid electrolyte raw material, i.e., the sulfide-based raw material and the lithium sulfide, is vulnerable to air and water.

For more effective removal of air and water, the valve 90 may be located on the first transport pipe 81 and the third transport pipe 83 close to the storage reservoir 50.

According to the second exemplary embodiment of the present invention, the solid electrolyte raw material initially held in the storage reservoir 50 is introduced by the circulation pump 70 into the reaction tube 61 through the first transport pipe 81 and the second transport pipe 82, is reacted by receiving energy from the ultrasound irradiation means 62 as it passes through the reaction tube 61 and then introduced again into the storage reservoir 50 through the third transport pipe 83. According to the second exemplary embodiment of the present invention, a solid electrolyte is synthesized as the solid electrolyte raw material is circulated repeatedly. Hereinafter, a method for preparing a solid electrolyte using the continuous circulation reactor is described in detail.

The method for preparing a solid electrolyte using a sonochemical process according to the second exemplary embodiment of the present invention uses the continuous circulation reactor and includes a step of allowing the solid electrolyte raw material held in the storage reservoir 50 to pass through the first transport pipe 81, the circulation pump 70 and the second transport pipe 82 and to flow into the reaction tube 61 of the ultrasound generator 60, a step of reacting the solid electrolyte raw material by irradiating an ultrasound with the ultrasound irradiation means 62 to the solid electrolyte raw material flowing in the reaction tube 61 and a step of flowing the solid electrolyte raw material discharged from the reaction tube 61 through the third transport pipe 83 into the storage reservoir 50, wherein the steps are repeated several times.

The method for preparing a solid electrolyte using a sonochemical process according to the second exemplary embodiment of the present invention may further include, before circulating the solid electrolyte raw material held in the storage reservoir 50, a step of removing the air and water remaining in the transport pipe 80 by injecting an inert gas, etc. through the valve 90 equipped on the first transport pipe 81 and the third transport pipe 83.

Then, the solid electrolyte raw material held in the storage reservoir 50 is flown into the reaction tube 61 of the ultrasound generator 60 by operating the circulation pump 70.

When the solid electrolyte raw material passes through the reaction tube 61, the ultrasound irradiation means 62 applies an ultrasound to the reaction tube 61. As a result, energy of high temperature and pressure is delivered into the reaction tube 61 and the solid electrolyte is synthesized from the reaction of the solid electrolyte raw material.

Specifically, the flow rate of the solid electrolyte raw material passing through the cross section of the reaction tube 61 may be 0.01-50 m/min. If the flow rate is lower than 0.01 m/min, reaction may occur only locally inside the reaction tube. And, if the flow rate exceeds 50 m/min, the solid electrolyte may not be synthesized due to insufficient energy applied to the solid electrolyte raw material.

The ultrasound irradiation means 62 may irradiate an ultrasound with a frequency of 20-2,000 kHz. In addition, the temperature of the reaction tube 61 may be controlled to −50° C. to 200° C. The temperature of the reaction tube 61 may be controlled by various methods. For example, it may be controlled by equipping a temperature sensor and a temperature controller inside or near the ultrasound generator 60. Alternatively, the continuous circulation reactor may be housed in a chamber and the temperature of the whole chamber may be controlled.

However, the frequency of the ultrasound irradiation means 62 and the temperature of the reaction tube 61 are not limited thereto but may be changed adequately depending on the flow rate of the solid electrolyte, ultrasound irradiation time, the kind of the solid electrolyte raw material or the state of the solid electrolyte raw material. Also, they may be constant or varying.

Some of the solid electrolyte raw material is synthesized into the solid electrolyte in the reaction tube 61 and the remainder is introduced again into the storage reservoir 50 through the third transport pipe 83.

The circulation of the solid electrolyte raw material may be conducted repeatedly until all the solid electrolyte raw material is reacted to synthesize the solid electrolyte. Specifically, the steps described above may be repeated for 1 minute to 6 hours.

The method for preparing a solid electrolyte using a sonochemical process according to the second exemplary embodiment of the present invention may further include, after the circulation of the solid electrolyte raw material has been completed, a step of drying the obtained product. Although the drying condition is not particularly limited, it may be conducted specifically under a vacuum condition in order to prevent side reactions and reduce drying time.

In addition, the method for preparing a solid electrolyte may further include a step of heat-treating the dried product. It is to crystallize the dried solid electrolyte through heat treatment.

The heat treatment may be conducted at 250-800° C. for 1 minute to 100 hours. If the heat treatment temperature is below 250° C. and the heat treatment time is shorter than 1 minute, it may be difficult for the solid electrolyte form a crystal structure. In addition, if the heat treatment temperature exceeds 800° C. and the heat treatment time exceeds 100 hours, the lithium ion conductivity of the solid electrolyte may be decreased due to change in composition caused by evaporation of components.

The present invention will be described in more detail through examples. The following examples are for illustrative purposes only and it will be apparent to those skilled in the art that the scope of this invention is not limited by the examples.

### Example 1—Synthesis of Solid Electrolyte According to First Exemplary Embodiment (without Heat Treatment)

0.75 g of a solid electrolyte raw material was prepared by mixing lithium sulfide (Li₂S) and diphosphorus pentasulfide (P₂S₅) at a molar ratio of 70:30. The solid electrolyte raw material was loaded in a gas-tight vial holding 6 mL of ethyl propionate (C₅H₁₀O₂).

The vial was sealed and then immersed in a water bath equipped with an ultrasound generating apparatus as shown in FIG. 3. The solid electrolyte raw material was reacted by irradiating an ultrasound with a frequency of 45 kHz at a power of about 140 W for about 2 hours. The reaction temperature was room temperature, or about 25° C. The reaction temperature was maintained at room temperature by the water bath.

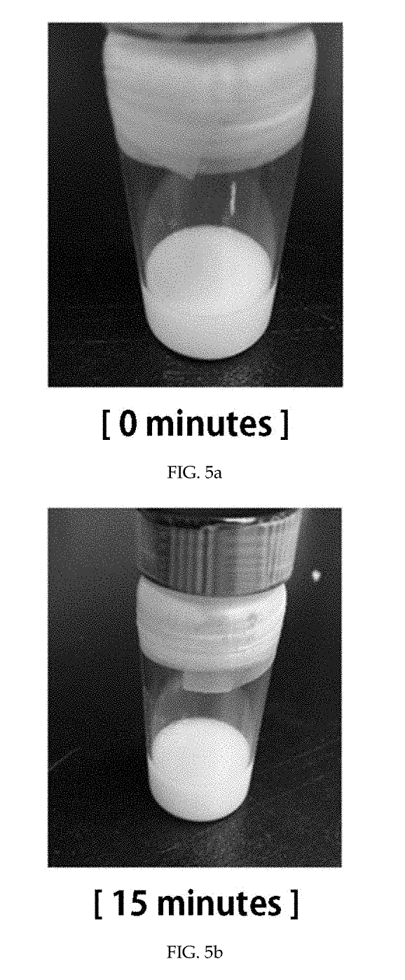

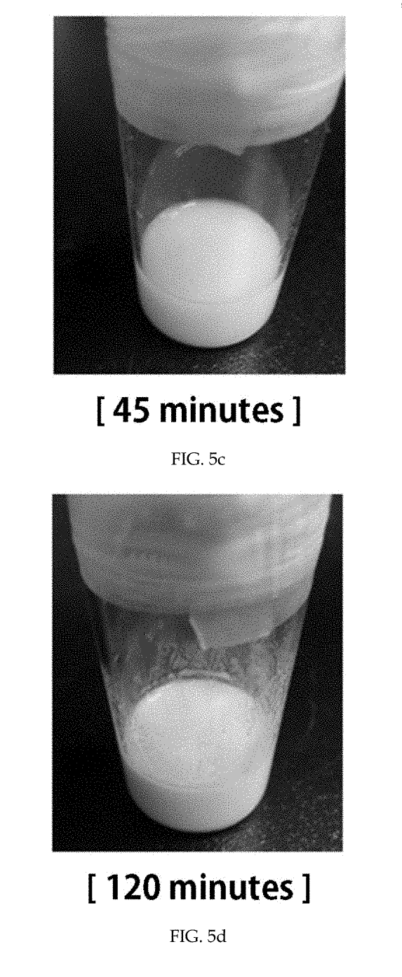

FIGS. 5A-5D show a result of monitoring the change of the solid electrolyte raw material depending on reaction time (FIG. 5A: before the start of reaction, FIG. 5B: after reaction for 15 minutes, FIG. 5C: after reaction for 45 minutes, FIG. 5D: after reaction for 120 minutes). Referring to the figures, it can be seen that, before the start of reaction (FIG. 5A), undissolved powders were settled in a milk-white solution. 15 minutes after the reaction (FIG. 5B), the settled powders disappeared completely and the solution turned slightly yellow. 45 minutes after the reaction (FIG. 5C), an opaque dark-yellow solution clearly distinguished from the initial state (FIG. 5A) was obtained. 120 minutes after the reaction (FIG. 5D), a milk-white solution was formed again but with an increased viscosity, suggesting that the solid electrolyte was synthesized.

The product obtained by reacting the solid electrolyte raw material was dried under a vacuum condition at about 160° C. for about 1 hour to obtain a solid electrolyte in a powder form.

### Example 2—Synthesis of Solid Electrolyte According to First Exemplary Embodiment (with Heat Treatment)

The solid electrolyte powder obtained in Example 1 was heat-treated under an argon gas atmosphere at about 260° C. for about 2 hours to obtain a crystallized solid electrolyte (70Li₂S.30P₂S₅, Li₇P₃S₁₁).

### Example 3—Synthesis of Solid Electrolyte According to Second Exemplary Embodiment (without Heat Treatment)

0.75 g of a solid electrolyte raw material was prepared by mixing lithium sulfide and diphosphorus pentasulfide at a molar ratio of 75:25. The solid electrolyte raw material was loaded in a gas-tight vial holding 6 mL of ethyl propionate.

After installing a continuous circulation reactor as shown in FIG. 4, the air and water remaining in a transport pipe was removed by purging with argon gas through a three-way-valve equipped on the transport pipe. Then, a solid electrolyte raw material in a storage reservoir was circulated by operating the circulation pump.

The output of the circulation pump was set such that the solid electrolyte raw material passed through the cross section of a reaction tube at a flow rate of 2.5 m/min and an ultrasound with a frequency of 26 kHz and a power of about 200 W was irradiated with an ultrasound irradiation means to the reaction tube. The temperature of the reaction tube was maintained at room temperature, or about 25° C., using a temperature controller (water-cooled device equipped inside an ultrasound generator).

The solid electrolyte raw material was reacted by operating the continuous circulation reactor for about 1 hour.

A product obtained after the operation was completed was dried under a vacuum condition at about 160° C. for about 1 hour to obtain a solid electrolyte in a powder form.

### Example 4—Synthesis of Solid Electrolyte According to Second Exemplary Embodiment (with Heat Treatment)

The solid electrolyte powder obtained in Example 3 was heat-treated under an argon gas atmosphere at about 260° C. for about 2 hours to obtain a crystallized solid electrolyte (75Li₂S.25P₂S₅, Li₃PS₄).

### Comparative Example 1—Synthesis of Solid Electrolyte Through Mechanical Milling (without Heat Treatment)

0.75 g of a solid electrolyte raw material was prepared by mixing lithium sulfide and diphosphorus pentasulfide at a molar ratio of 70:30. The solid electrolyte raw material was put in a zirconia milling container holding a crushing medium. A zirconia bead (3 mm in diameter) was used as the crushing medium.

The solid electrolyte raw material was pulverized continuously by planetary milling at about 500 rpm for about 9 hours.

Then, a solid electrolyte powder was recovered through sieving.

### Comparative Example 2—Synthesis of Solid Electrolyte Through Mechanical Milling (with Heat Treatment)

The solid electrolyte powder obtained in Comparative Example 1 was heat-treated under an argon gas atmosphere at about 260° C. for about 2 hours to obtain a crystallized solid electrolyte (70Li₂S.30P₂S₅, Li₇P₃S₁₁).

### Comparative Example 3—Synthesis of Solid Electrolyte Through Mechanical Milling (without Heat Treatment)

A solid electrolyte was synthesized in the same manner as in Comparative Example 1, except that lithium sulfide and diphosphorus pentasulfide were mixed at a molar ratio of 75:25.

### Comparative Example 4—Synthesis of Solid Electrolyte Through Mechanical Milling (with Heat Treatment)

The solid electrolyte powder obtained in Comparative Example 3 was heat-treated under an argon gas atmosphere at about 260° C. for about 2 hours to obtain a crystallized solid electrolyte (75Li₂S.25P₂S₅, Li₃PS₄).

### Test Example 1

The microstructure and powder shape of the solid electrolytes prepared in Examples 1-4 and Comparative Examples 1-4 were analyzed by scanning electron microscopy.

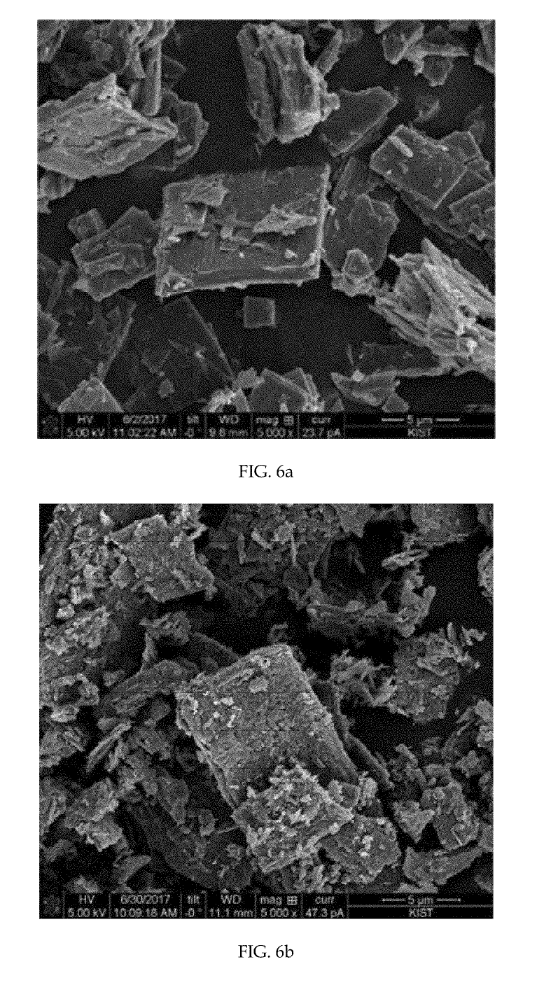

FIG. 6A shows a scanning electron microscopy analysis result of the solid electrolyte according to Example 1 and FIG. 6B shows a scanning electron microscopy analysis result of the solid electrolyte according to Example 2. Referring to the figures, it can be seen that the solid electrolyte prepared by a sonochemical process according to the first exemplary embodiment of the present invention mainly has a plate shape.

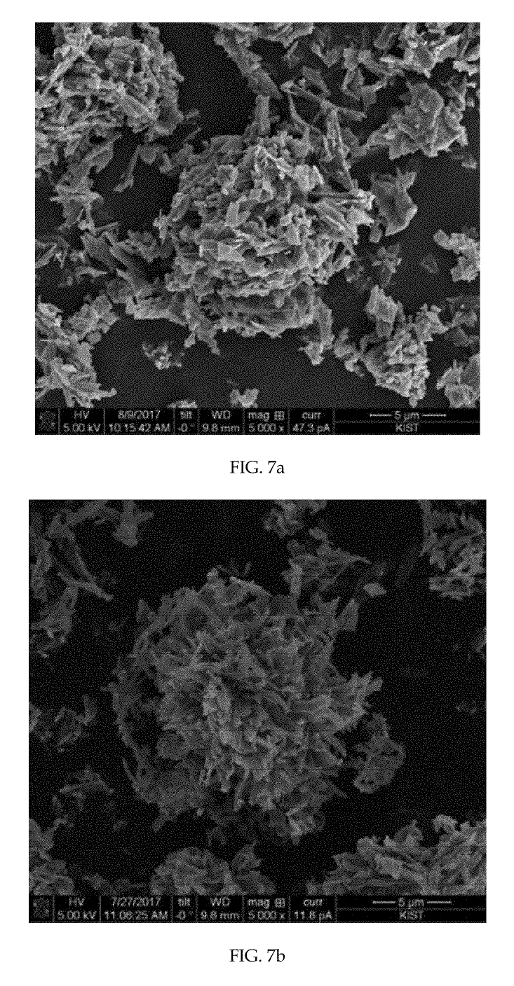

FIG. 7A shows a scanning electron microscopy analysis result of the solid electrolyte according to Example 3 and FIG. 7B shows a scanning electron microscopy analysis result of the solid electrolyte according to Example 4. Referring to the figures, it can be seen that the solid electrolyte prepared by a sonochemical process according to the second exemplary embodiment of the present invention mainly has a needle shape.

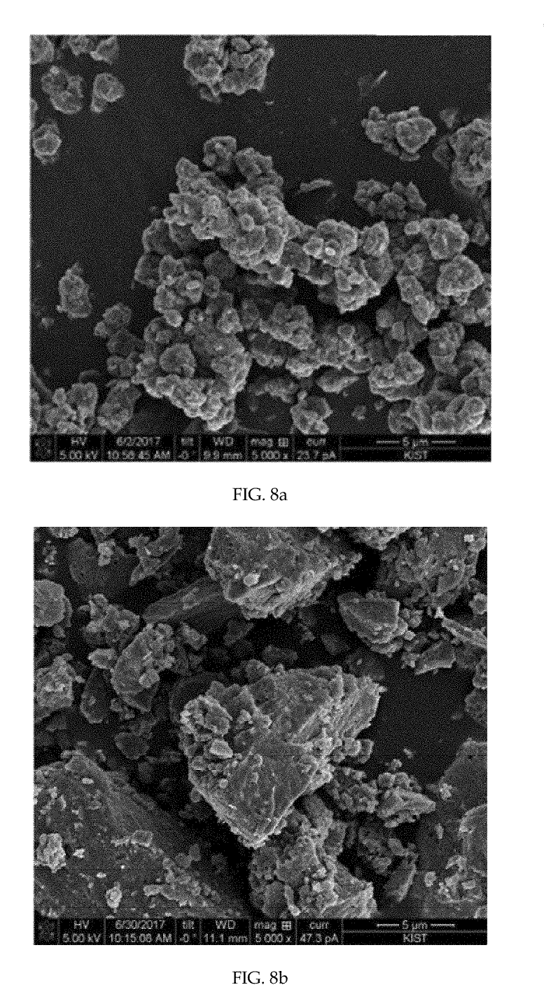

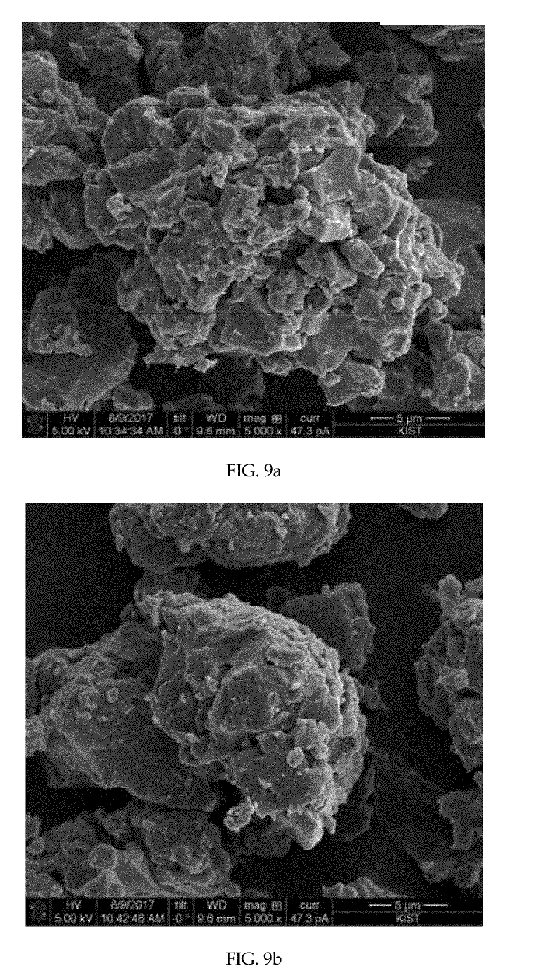

FIG. 8A shows a scanning electron microscopy analysis result of the solid electrolyte according to Comparative Example 1, FIG. 8B shows a scanning electron microscopy analysis result of the solid electrolyte according to Comparative Example 2, FIG. 9A shows a scanning electron microscopy analysis result of the solid electrolyte according to Comparative Example 3 and FIG. 9B shows a scanning electron microscopy analysis result of the solid electrolyte according to Comparative Example 4. Referring to the figures, it can be seen that, unlike the present invention, the solid electrolyte synthesized through mechanical milling exists as a coarse aggregate having an irregular sphere shape.

From Test Example 1, it can be seen that the solid electrolyte prepared by a sonochemical process according to the present invention has a plate or needle shape unlike the existing solid electrolyte.

### Test Example 2

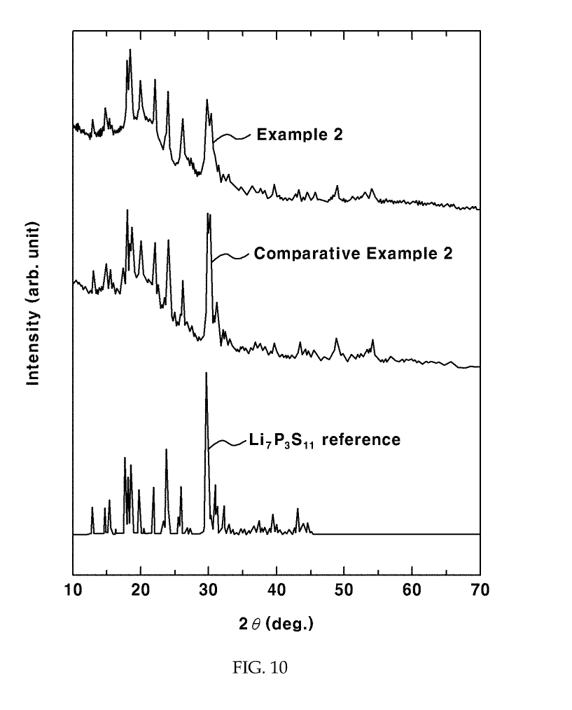

X-ray diffraction analysis was conducted to investigate the crystal structure of the solid electrolytes according to Example 2 and Comparative Example 2. The result is shown in FIG. 10. A major peak around 30° and four peaks between 20° and 27°, which are characteristic of Li₇P₃S₁₁, were observed for both Example 2 and Comparative Example 2. Accordingly, it can be seen that, when a solid electrolyte is prepared by a sonochemical process according to the first exemplary embodiment of the present invention, the crystal phase of Li₇P₃S₁₁ is formed clearly.

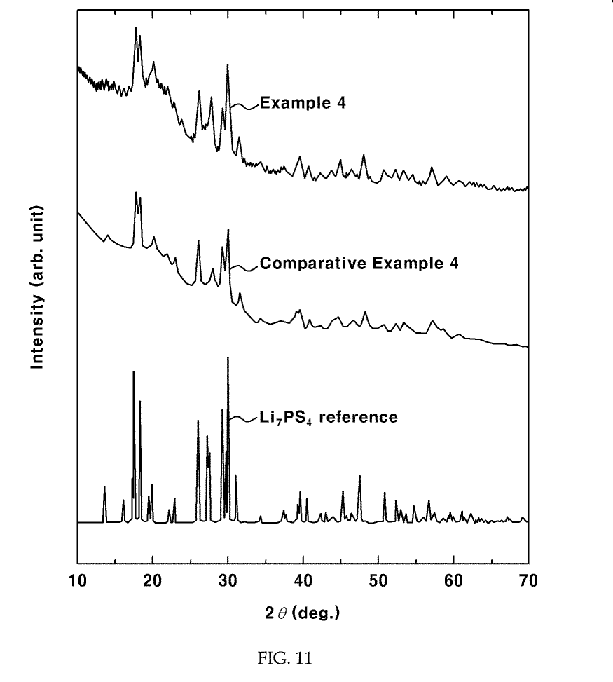

Also, X-ray diffraction analysis was conducted to investigate the crystal structure of the solid electrolytes according to Example 4 and Comparative Example 4. The result is shown in FIG. 11. A major peak around 30° and two peaks between 18° and 20°, which are characteristic of Li₃PS₄, were observed for both Example 4 and Comparative Example 4. Accordingly, it can be seen that, when a solid electrolyte is prepared by a sonochemical process according to the second exemplary embodiment of the present invention, the crystal phase of Li₃PS₄ is formed clearly.

### Test Example 3

AC impedance analysis was conducted at room temperature in order to measure the lithium ion conductivity of the solid electrolytes according to Example 2 and Example 4.

After loading the solid electrolyte on a SUS (steel use stainless) mold for conductivity measurement, a sample with a diameter of 6 mm and a thickness of 0.6 mm was prepared by conducting uniaxial cold pressing at 300 MPa. The impedance value of the sample was measured by applying an AC voltage of 50 mV and sweeping frequency from 1×10⁷ to 100 Hz

As a result, the lithium ion conductivity of the solid electrolytes according to Example 2 and Example 4 was measured to be about 0.22 mS/cm and 0.22 mS/cm, respectively.

The present invention has been described in detail with reference to specific embodiments thereof. However, it will be appreciated by those skilled in the art that various changes and modifications may be made in these embodiments without departing from the principles and spirit of the invention, the scope of which is defined in the appended claims and their equivalents.

What is claimed is:

1. A method for preparing a solid electrolyte using a sonochemical process, comprising:
preparing a reaction vessel holding a solid electrolyte raw material in a liquid form; and
reacting the solid electrolyte raw material by applying energy into the reaction vessel by irradiating an ultrasound to the reaction vessel.

2. The method for preparing a solid electrolyte using a sonochemical process according to claim 1, wherein the solid electrolyte raw material comprises:
10-40 mol % of a sulfide-based raw material selected from a group consisting of P₂S₃, P₂S₅, P₄S₃, P₄S₅, P₄S₇, P₄S₁₀ and a combination thereof; and
60-90 mol % of lithium sulfide (Li₂S).

3. The method for preparing a solid electrolyte using a sonochemical process according to claim 1, wherein the solid electrolyte raw material is dissolved in a polar organic solvent selected from a group consisting of an ester-based solvent, a carbonate-based solvent, an ether-based solvent, a furan-based solvent and a combination thereof.

4. The method for preparing a solid electrolyte using a sonochemical process according to claim 1, wherein reacting the solid electrolyte raw material is conducted by irradiating an ultrasound with a frequency of 20-2,000 kHz to the reaction vessel for 1 minute to 6 hours.

5. The method for preparing a solid electrolyte using a sonochemical process according to claim 1, wherein reacting the solid electrolyte raw material is conducted at −50° C. to 200° C.

6. The method for preparing a solid electrolyte using a sonochemical process according to claim 1, wherein reacting the solid electrolyte raw material comprises sealing the reaction vessel, immersing the reaction vessel in a water bath equipped with an ultrasound generating apparatus and filled with a medium and then irradiating an ultrasound to the reaction vessel.

7. The method for preparing a solid electrolyte using a sonochemical process according to claim 1, which further comprises drying a product obtained by reacting the solid electrolyte raw material.

8. The method for preparing a solid electrolyte using a sonochemical process according to claim 7, which further comprises heat-treating the dried product at 250-800° C. for 1 minute to 100 hours.

9. The method for preparing a solid electrolyte using a sonochemical process according to claim 1, wherein the solid electrolyte has a shape selected from a group consisting of a sphere, a plate, a needle and a combination thereof.

10. A continuous circulation reactor for preparing a solid electrolyte using a sonochemical process, comprising:
a storage reservoir holding a solid electrolyte raw material in a liquid form;
an ultrasound generator comprising a reaction tube and an ultrasound irradiation means which is located outside the reaction tube and reacts the solid electrolyte raw material by applying energy into the reaction tube by irradiating an ultrasound to the reaction tube;
a first transport pipe one end of which is inserted in the storage reservoir and contacts the solid electrolyte raw material and the other end of which is connected to a circulation pump; a second transport pipe one end of which is connected to the circulation pump and the other end of which is linked with one end of the reaction tube; and a third transport pipe one end of which is linked with other end of the reaction tube and the other end of which is inserted in the storage reservoir; and
the circulation pump which allows the solid electrolyte raw material to flow from the storage reservoir through the reaction tube and again into the storage reservoir.

11. The continuous circulation reactor for preparing a solid electrolyte using a sonochemical process according to claim 10, wherein the solid electrolyte raw material comprises:
10-40 mol % of a sulfide-based raw material selected from a group consisting of P₂S₃, P₂S₅, P₄S₃, P₄S₅, P₄S₇, P₄S₁₀ and a combination thereof; and
60-90 mol % of lithium sulfide (Li₂S).

12. The continuous circulation reactor for preparing a solid electrolyte using a sonochemical process according to claim 10, wherein the solid electrolyte raw material is dissolved in a polar organic solvent selected from a group consisting of an ester-based solvent, a carbonate-based solvent, an ether-based solvent, a furan-based solvent and a combination thereof.

13. The continuous circulation reactor for preparing a solid electrolyte using a sonochemical process according to claim 10, wherein the flow rate of the solid electrolyte raw material passing through the cross section of the reaction tube is 0.01-50 m/min.

14. The continuous circulation reactor for preparing a solid electrolyte using a sonochemical process according to claim 10, wherein the ultrasound irradiation means irradiates an ultrasound with a frequency of 20-2,000 kHz.

15. The continuous circulation reactor for preparing a solid electrolyte using a sonochemical process according to claim 10, which further comprises a temperature controller controlling the temperature of the reaction tube to −50° C. to 200° C.

16. A method for preparing a solid electrolyte using a sonochemical process, which uses the continuous circulation reactor according to claim 10, comprises:
allowing the solid electrolyte raw material held in the storage reservoir to pass through a first transport pipe, the circulation pump and the second transport pipe and to flow into the reaction tube of the ultrasound generator;
reacting the solid electrolyte raw material by irradiating an ultrasound to the solid electrolyte raw material flowing in the reaction tube; and
flowing the solid electrolyte raw material discharged from the reaction tube through the third transport pipe into the storage reservoir,
wherein the steps are repeated.

17. The method for preparing a solid electrolyte using a sonochemical process according to claim 16, wherein the steps are repeated for 1 minute to 6 hours.

18. The method for preparing a solid electrolyte using a sonochemical process according to claim 16, which further comprises drying a product obtained by repeating the steps.

19. The method for preparing a solid electrolyte using a sonochemical process according to claim 18, which further comprises heat-treating the dried product at 250-800° C. for 1 minute to 100 hours.

20. The method for preparing a solid electrolyte using a sonochemical process according to claim 16, wherein the solid electrolyte has a shape selected from a group consisting of a sphere, a plate, a needle and a combination thereof.
